(19) United States
(12) Patent Application Publication
(10) Pub. No.: US 2004/0105520 A1
(43) Pub. Date: Jun. 3, 2004

(54) Method and apparatus for the ex-core production of nuclear isotopes in commercial PWRs

(76) Inventor: Gary Shelton Carter, Troutville, VA (US)

Correspondence Address: GARY SHELTON CARTER, 250 KNOLLWOOD DRIVE, TROUTVILLE, VA, 24175, US

(21) Appl. No.: 10/458,479

(22) Filed: Jun. 10, 2003

Related U.S. Application Data
(60) Provisional application No. 60/393,855, filed on Jul. 8, 2002.

(51) Int. Cl. G21G 1/06

(52) U.S. Cl. 376/268

(57) ABSTRACT

Method and apparatus for utilizing currently operating commercial electric Pressurized Water Reactor (PWR) core former plate cooling water flow holes for the ex-core production of nuclear isotopes. In operating PWRs with existing, or modified, core former plates (3) incorporating in-line coolant flow holes (4), it is possible to directly access and install isotope target materials inside an isotope target holder (2) that is connected to a flow enabler (1). The axial mid-plane of a flow enabler (1) would be located at the elevation of the core former plates (3). Thus by continuing the assembly of an isotope target holder (3) both above and below a flow enabler (1) such that a number of the isotope target holders (2) are located between the former plates, an isotope target holder assembly can be formed. The target holder assembly can then be directly inserted into, (or removed from) certain operating PWRs during normal reactor refueling operations. During refuel operations the upper flow holes (4) are exposed during the process of gaining access to the nuclear core. With the proposed ex-core isotope target holder assembly and integral flow enablers, a highly significant portion of the coolant flow can continue to pass through a selected series of in-line coolant flow holes (4). Thus commercial PWRs will be afforded a method and apparatus to produce commercially viable isotopes without any significant reactor equipment, refuel outage or fuel cycle management modifications.

### FIELD OF THE INVENTION

The invention concerns a method and an apparatus for enabling the utilization of existing design features of many currently operating commercial nuclear pressurized water reactors (PWRs) for the ex-core production of nuclear isotopes.

### BACKGROUND

The following is preceded by provisional patent application numbered 60/393,855 with filing date Jul. 8, 2002, also submitted by the current applicant with the provisional application also titled as currently submitted in this utility patent application.

In a number of operating Pressurized Water Reactors (PWRs), the core former plates have been fabricated with vertically in-line coolant flow holes (4) that are easily accessible during reactor refueling operations. Given the diameter (often equal or greater than 1-¼″), and the proximity of these groups of vertical in-line flow holes to the outer fuel assemblies of the nuclear core, and given their accessibility during reactor refueling operations, methods and apparatus have been conceived to permit the utilization of these existing but heretofore unavailable regions of commercial nuclear reactors for the production of nuclear isotopes.

These isotopes can now be generated in the existing and, in some cases, unmodified former plate regions of the reactor typically by thermal neutron capture inside target holders (2) containing encapsulated target materials.

The apparatus or device that facilitates and enables this economical production method is the flow enabler (1). The flow enablers can be located in the same planes as the core former plates (3), when the flow enablers are inserted through the accessible and vertically in-line former plate flow holes (4). Target holders (2) containing isotope production target materials are first connected above and below the flow enablers (1) and the resulting isotope target holder rod assemblies can then be inserted or removed during reactor refueling operations.

### BRIEF DESCRIPTION OF THE DRAWINGS

FIG. 1 shows a flow enabler (1) in a preferred embodiment configuration of approximately 1 to 3 inches in length. The flow enabler (1) in this configuration enables approximately 52% of the normally open frontal flow area in a 1-⅜″ diameter former plate coolant flow hole to be available for coolant flow. The center section of the flow enabler includes features for structural connections at either end. These connections permit the structural attachment of other entities such as the isotope target holder of the same or lesser diameter. Structural attachments can be made through pinned, or threaded connections or a combination of either of these. Other methods of structural attachment such as welding are also possible using the center section as given in FIG. 1. Flow opening dimensions can be varied to more greatly restrict/improve flow if required.

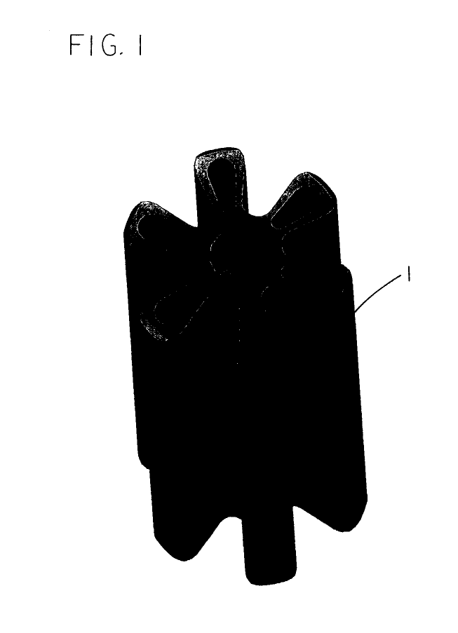

FIG. 2 shows a possible assembly configuration of a flow enabler (1) and a portion of an isotope target holder (2) that could be attached to one of the two center end sections of the flow enabler. A second isotope target holder (2) could also be structurally attached to the flow enabler (1) lower end to begin the formation of a string or series of flow enablers and target holders that would form a target holder assembly.

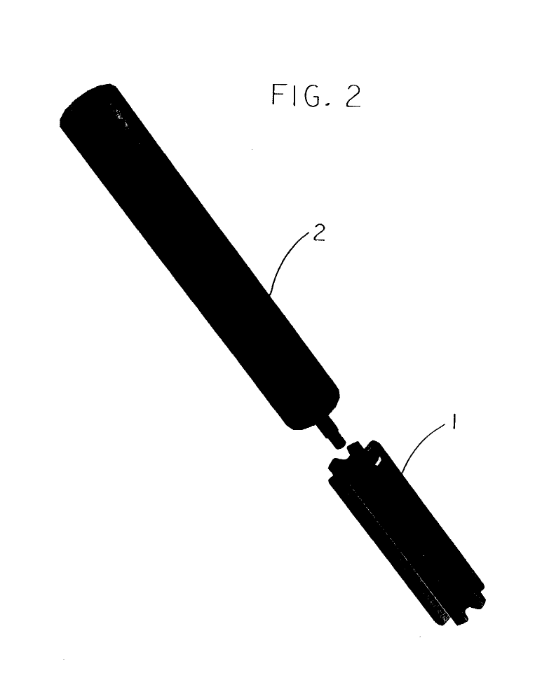

FIG. 3 shows an elevation view of a typical B&W designed 177-fuel assembly set of reactor internals with the plenum assembly not shown. The plenum assembly would normally fit inside the upper core support cylinder (7) during reactor operation. However, the plenum is removed during reactor refueling operations to expose the nuclear core and significant portions of the upper former plate (3) shown typically in FIG. 3. The eight mechanically similar former plates, shown in FIGS. 3 and 5, are structurally connected to baffle plates (5) that define the nuclear core structure, and also to the lower core support barrel cylinder (6) that provides the most significant outer structural containment and lateral support for the nuclear core contained inside the baffle plates (5).

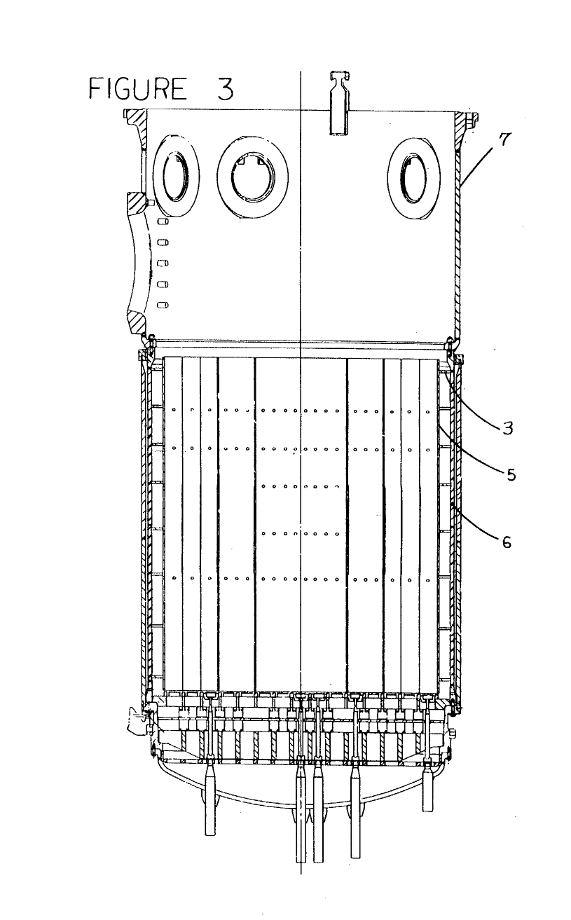

FIG. 4 shows a three-dimensional view of a typical former plate (3) with a standard arrangement and number of reactor coolant flow holes (4) that are machined completely through the steel former plate.

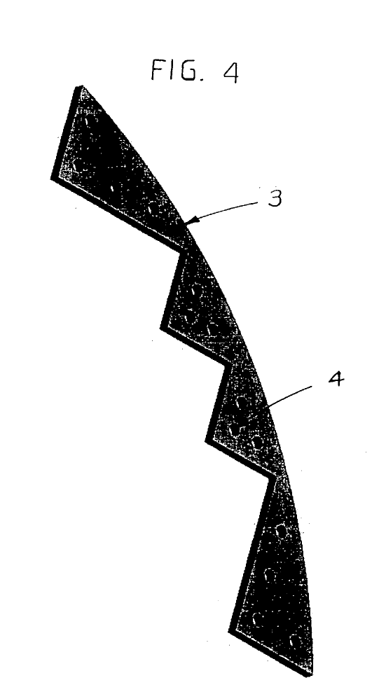

FIG. 5 presents a three dimensional arrangement of the eight similar former plates (3) found in a B&W 177 fuel assembly PWR. The reactor coolant flow holes (4) are machined in the former plates (3) such that the flow holes are typically in vertical alignment with each other in the assembled configuration. The vertically in-line features of the former plates and their coolant flow holes can be seen with this arrangement.

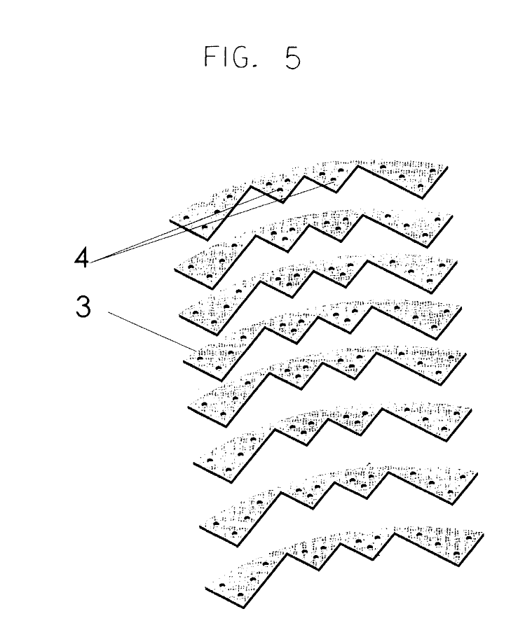

### DETAILED DESCRIPTION

In pressurized water reactors (PWRs), a number of horizontal former plates (3) surround the nuclear core comprised of individual nuclear fuel assemblies. These former plates help provide the structural support needed to sustain the reactor internal components from reactor coolant flow forces generated when the coolant flows through the nuclear core. The former plates also define the core reflector region of the PWR and the flow holes permit reactor coolant water flowing from bottom to top to cool this section of the reactor internals from both thermal and gamma heating, and to ensure the voids between the former plates that surround the nuclear core remain filled with water and thereby also improve core efficiency.

A small percentage of the core cooling flow is directed up through these former plates through coolant flow holes located in the former plates. These coolant flow holes in many PWRs are often in vertical alignment. Their placement in the former plates also allows proper pressure control of the space between the core and the core barrel cylinder or reflector region. The reflector region can also be defined generally as that volume of the reactor internals located directly outside the core between the core baffle plates (5) and the core barrel cylinder (6). The former plates therefore help define the outermost horizontal geometrical shape of the nuclear core, and provide structural support and especially help provide stability against the substantial hydraulic core coolant flow forces inside a typical PWR.

During PWR refueling operations, the nuclear core and also the upper former plates and their coolant flow holes are exposed when the reactor closure head and the upper internals or plenum assembly is removed. In certain PWR designs and especially in the B&W 177 fuel assembly reactor designs, the former plate coolant flow holes are generally in vertical alignment in each of the horizontal former plates. A number of these vertically aligned hole groups can be directly accessed during reactor refueling such that isotope target holders can be vertically inserted or removed during the refueling operations without any modification to the existing former plates or their coolant flow holes.

Since modification of the flow holes to accommodate insertion of isotope target holder assemblies would constitute a justifiable, but significant, expense and require slight but justifiable modification of the reactor internals, it would obviously be advantageous to utilize the existing in-line features of the former plate coolant flow holes for the purpose of isotope production provided adequate coolant flow through the former plates is still permitted. This becomes obvious through a reading of such patents as Boiron's et al (U.S. Pat. No. 4,462,956) where elaborate devices are envisioned in the former plate region to provide the method and means for core partitioning and isotope production. Nuclear isotope production potential in this region is also herein considered highly feasible since the PWR reactor vessel material integrity issue programs required by the U.S. Nuclear Regulatory Commission and 10CFR50 have helped demonstrate that the thermal neutron fluence in the vicinity of many of these flow holes rivals the thermal fluence at the core periphery.

It has been evaluated and established in various thermal-hydraulic analyses of PWR reactor internals designs, and especially in Westinghouse PWR designs where up-flow conversions where implemented, that plugging and adding of former and baffle plate coolant flow holes is practical, and can be safely implemented. Additionally, it has been established in current PWR design practice that the coolant flow and flow velocities in the former plate region are low when compared to flow volume and velocities through the core. A small partial (45 to 50%) frontal flow blockage in each of from one (1) to three (3) vertically in-line flow hole groups in each of the four reflector region quadrant former plate arrangements surrounding the reactor core in a B&W 177 Fuel assembly reactor has been reviewed and is considered to be within the design allowable pressure and coolant flow safety margin requirements through the former plates for the B&W designed 177 fuel assembly PWRs. It is therefore reasonable to expect similar hydraulic evaluation results for other currently operating PWRs with similar former plate designs. With multiple former plates and in-line flow holes through those plates, varying and divergent alternate flow paths are established in reaction to the partial flow blockage potentially encountered as a result of the insertion of an isotope target holder rod assembly that acts as a partial flow blocker.

Such partial blockage may actually prove to be beneficial in that in-line flow path arrangements can contribute to a more direct path for cooling flow through the former plates. The more direct flow path then helps foster regions between the former plates where there is a greater possibility of more stagnant or low flow in certain areas between the former plates. A primary purpose of the coolant flow through the former plate region is to limit the effects of gamma heating of the stainless steel reactor internals components such as the former and baffle plates or the core barrel. Thus a series of flow enablers (1) acting in one, two or three groups of vertically in-line former plate flow holes per quadrant is expected to slightly increase inter-former plate cooling circulation, without detrimental regional pressure gradient changes, and help to establish more indirect and alternative cooling flow paths between the former plates. Consideration has also been given by certain PWR designers to instituting mechanical blockage of targeted former plate flow holes in certain operating PWRs to help limit flow jetting induced wear on outer fuel rods caused by coolant flow through holes or slots originally designed into the core baffle plates (5).

The flow enablers (1) currently envisioned and shown are approximately one (1) to three (3) inches in axial length and in reactor operation their vertical mid-planes would be located and firmly positioned at the center of the former plate (3) thickness. The flow enabler (1) in its preferred structural embodiment would restrict no more than 48% of any single currently available former plate coolant flow frontal hole area. The center section of the flow enabler is designed to permit a structural connection at either end such that some manner of isotope target holder assembly (2) can be attached and fixed together for insertion and removal from the core support assembly former plates during reactor refueling, and then be held fixed inside the reactor by any manner of devices herein not shown during reactor operation.

Also during reactor internals former plate up-flow conversions, it has been established that quick, reliable, and accurate methods exist for modifying the irradiated former plates through the addition or modification of new or existing coolant flow or access holes primarily through the use of electric discharge machining (EDM). However, greater economic advantage can obviously be realized in the ex-core production of nuclear isotopes if only minor, or no, modifications to the former plates are required.

It has also been well established in PWR analyses, evaluations, and testing for effects of neutron irradiation on reactor pressure vessel steels, that the thermal neutron fluence levels in the reflector region at the former plates is more than adequately high for significant production of many nuclear isotopes, even in low leakage PWR core designs. Average thermal neutron fluence levels at many of the existing former plate coolant flow hole locations can rival or exceed the thermal fluence levels at the outer peripheral fuel assembly locations given the significant contributions to the thermal flux due to the thermalization of fast neutrons in the reflector region.

Additionally, because of the location of the closest former plate coolant flow holes to the outer fuel assemblies, and the fact these holes are a significant number of mean free neutron path distances away, little or no impact on core performance or fuel management will occur due to the insertion of from one to three isotope target holder and flow enabler assemblies per reactor quadrant. Furthermore, the thermal neutrons in this reflector region that are normally free and unproductive will be available for the thermal neutron capture production of many useful nuclear isotopes.

I claim:

1. A device that is capable of being inserted into and/or through, and then removed from, existing reactor coolant flow holes in the former plates of pressurized water reactors during reactor refueling operations, where the said device permits a minimum of 52% of the normally available frontal flow area through the flow hole such that the flow hole remains open and is not totally blocked for coolant flow through the former plate hole, while also providing structural attachments at either end for nuclear isotope target holders to be located between two vertically adjacent former plates that contain coolant flow hole diameters and patterns such that any one of many possible flow holes in the uppermost former plate is in vertical axial alignment with a series of similar flow holes in former plates at increasingly lower elevations inside the core support structure of the reactor, with the said device comprising
(a) a circular hub and attached radial spoke configuration wherein the frontal flow area between adjacent spokes is, in its preferred embodiment, uniformly open along the length between the spokes to allow the passage of reactor coolant flow, and
(b) where the outermost radial ends of the uniform structural spoke arrangements define a cylinder with a diameter slightly less than the former plate coolant flow hole diameter, such that when in contact the ends of the spokes present a radial load bearing surface against the sides of the former plate coolant flow holes, and
(c) where the lateral positioning and centering features of the radial spokes locate the hub and its structural end attachment features in the approximate center of the former plate coolant flow hole, and
(d) where each radial spoke has a vertical slot opening completely through the spoke such that reactor coolant can not only flow between adjacent spokes, but the coolant can also flow through the full axial length of each individual spoke in the device thus providing an even greater available coolant frontal flow area for reactor coolant to flow through the spokes and thus also through the former plate coolant flow holes while simultaneously providing structural support and locating features for attaching isotope target holders at either or both ends of the device, and
(e) where the preferred structural attachment features at both ends of the device are located in the center of the device hub such that threaded, pinned, welded or other similar structural connections can be made, and
(f) where the outer ends of the spoke features on both the top and bottom of the device are chamfered to assist with the remote insertion and removal of the device through multiple and vertically in-line former plate coolant flow holes.

2. A method whereby existing, in-line and vertically accessible reactor coolant flow holes located in the former plates of pressurized water reactors can be utilized for the insertion and removal of assembled nuclear isotope production target holders containing flow enabler connecting hardware, during reactor refueling operations.

3. A method whereby existing, in-line and vertically accessible reactor coolant flow holes located in the former plates of pressurized water reactors can be utilized for the insertion and removal of nuclear isotope production target holders and connecting hardware that includes a reactor coolant flow enabling device which not only provides structural support and connectivity for the isotope target holders that can be located at either end of the device, but also through its unique design, enables a second function of continuing to provide a nominal 52% of the previously available frontal flow area for the reactor coolant flow that normally flows through the coolant flow holes in the core former plates of operating pressurized water reactors and thus makes practical, during reactor refueling operations, the utilization of vertically accessible and in-line flow holes in the reactor core support former plates for the purpose of producing nuclear isotopes outside the nuclear core in a region of the reactor internals where the neutron fluence is sufficient to irradiate target materials designed for the subsequent production of nuclear isotopes during reactor operation.

4. A method according to claim 3 whereby multiple flow enabling devices and multiple isotope target holders can be incorporated into a single isotope target holder hardware assembly such that by inserting the hardware assembly through vertically in line former plate flow holes and supporting the hardware assembly from the uppermost former plate, in a preferred embodiment, a hardware assembly arrangement can be achieved that locates a series of flow enablers at the elevations of the former plates and thereby provides the additional means to locate a series of interconnected isotope target holders of a diameter lesser than the flow holes such that they can be positioned between one or more of the former plates.

5. A method according to claim 4 whereby from 1 to 3 isotope target holder assemblies can be inserted during refueling operations, and then later, after power operations, and during a subsequent refueling operation, removed from the former plates in each of the four quadrants of a Babcock & Wilcox designed 177 fuel assembly pressurized water reactor.

6. A method according to claim 4 whereby a target holder assembly can be inserted and removed from a series of vertically in line former plate flow holes wherein one or more of the flow holes requires modification or enlargement such as to reach a uniform diameter with the other in line series of holes, thus allowing the extension in length of the target holder assembly.

7. A method according to claim 4 whereby a target holder assembly can be inserted and removed from a series of vertically in-line former plate flow holes wherein one or more of the flow holes requires generation or relocation such as to reach a uniform diameter and vertical alignment with the other vertically in line series of holes.

8. A method according to claim 3 whereby a number of in-line flow holes in the former plates can be utilized for isotope production when supplemented or modified by adding additional vertically in-line flow holes to former plates devoid of a comparable hole either below or above existing in line former plate flow holes.

9. A method according to claim 3 whereby a series of vertically in-line flow holes, comprised of one hole per former plate, can be generated in a series of vertically stacked former plates, either by EDM, or other appropriate machining methods, for the purpose of isotope production, and where the dimensions of the flow enabler can be varied to offer increased resistance to coolant flow through the new holes as would be required.
